(19) United States
(12) Patent Application Publication
(10) Pub. No.: US 2014/0129638 A1
(43) Pub. Date: May 8, 2014

(54) INFORMATION COMMUNICATION APPARATUS, INFORMATION COMMUNICATION METHOD, INFORMATION COMMUNICATION SYSTEM, AND COMPUTER PROGRAM

(71) Applicant: SONY CORPORATION, Tokyo (JP)

(72) Inventors: Kiran JOY, Tokyo (JP); Naoyuki SATO, Tokyo (JP)

(73) Assignee: SONY CORPORATION, Tokyo (JP)

(21) Appl. No.: 14/049,472

(22) Filed: Oct. 9, 2013

(30) Foreign Application Priority Data
Nov. 2, 2012 (JP) 2012243124

(51) Int. Cl. H04L 29/08

(52) U.S. Cl. CPC H04L 67/22
USPC 709/204

(57) ABSTRACT

An information communication apparatus includes a communication unit, a detection unit, and a social network processing unit. The communication unit is configured to connect to a network. The detection unit is configured to detect an operation performed by a user in a real world. The social network processing unit is configured to perform a predetermined process on a social network service based on the detection results obtained from the detection unit via the communication unit.

### CROSS REFERENCE TO RELATED APPLICATIONS

This application claims the benefit of Japanese Priority Patent Application JP 2012-243124 filed Nov. 2, 2012, the entire contents of which are incorporated herein by reference.

### BACKGROUND

The present disclosure relates to an information communication apparatus, an information communication method, an information communication system, and a computer program, which input/output information to/from a social medium, and particularly to an information communication apparatus, an information communication method, an information communication system, and a computer program, which input/output information on an event existed in a real world, e.g., real product, to/from a social medium.

In recent years, the number of users of social network services such as Facebook, Twitter, and YouTube has been rapidly increased. In the social network services, a social medium that connects the users with each other using a text, a still image, and a movie is provided. The users have more opportunities to search for a product or service with the help of a recommendation from a friend or a community via the social medium.

The social network services are used as a means of communication between the users, and have a function to manage the connections between the users, e.g., friendships. For example, a social graph updating system in which a social graph is updated to a new one corresponding to the current connections between the users by using communication histories in portable terminals held by the users has been proposed (see, for example, Japanese Patent Application Laid-open No. 2012-13375).

Many of the social network services provide a social button for a user to input/output information to/from a social medium, such as “Like,” “Share,” and “Tweet,” in the web page of each social network service. If a user clicks a social button, the result is reflected on the web pages of other users connected with the user by the above-mentioned management function. Specifically, the user can express his/her interests or concerns to the community by the simple operation of clicking the social button.

Along with the popularization of social networks, also companies use the social networks as an advertising medium of the in-house product. For example, an advertisement distribution method of distributing an e-mail intended for a user using a social network service, in which an advertisement selected based on user's profile information is inserted, has been proposed (see, for example, Japanese Patent Application Laid-open No. 2008-210304). Moreover, the above-mentioned social buttons such as “Like” and “Share” are placed in almost all product web pages created by the companies.

In the product web pages, still images, movies, and the like of the products are attached. However, information in the product pages is only information in a virtual world. Therefore, it may be impossible for a user being a consumer to accurately obtain information on the real product, i.e., information in the real world, on the product pages. On the other hand, the user can understand more about the product displayed in the real world, e.g., in a store, by seeing the product actually. However, the user has no direct means for inputting/outputting information from the real world to the social medium. Therefore, it may be impossible for the user to express him/her interests or concerns about the real world, e.g., real product, to the community in the virtual world, i.e., social network easily. On the contrary, also interests or concerns about the real world of other users in the community are not expressed to him/her.

The user needs to search for a product page in the social network or on the Internet and to operate a social button placed in the page in order to express his/her opinion on the real world, e.g., displayed product, or to hear other user's opinions in the community. Specifically, it is troublesome for the user to perform an operation of expressing his/her interests or concerns about the real world, e.g., exhibits, to the community in the virtual world.

### SUMMARY

It is desirable to provide an excellent information communication apparatus, information communication method, information communication system, and computer program, which are capable of inputting/outputting information obtained in a real world, e.g., real product, to/from a social medium by a simple operation without using a product page or the like.

The present disclosure has been made in view of the above-mentioned problem. According to an embodiment of the present disclosure, there is provided an information communication apparatus including a communication unit configured to connect to a network, a detection unit configured to detect an operation performed by a user in a real world; and a social network processing unit configured to perform a predetermined process on a social network service based on the detection results obtained from the detection unit via the communication unit.

The detection unit includes a tag reader and is configured to detect an operation in which the user passes a main body of the information communication apparatus over a non-contact tag, the tag reader being configured to read information from the non-contact tag, and the social network processing unit is configured to perform a predetermined process on the social network service in response to the operation in which the user passes the main body of the information communication apparatus over the non-contact tag.

The social network processing unit is configured to perform a predetermined process on the social network service based on the information read from the non-contact tag by the tag reader.

The non-contact tag is placed near one of an object and an event in the real world, and the social network processing unit is configured to perform a predetermined process on a social network service associated with one of the object and the event in response to the operation in which the user passes the main body of the information communication apparatus over the non-contact tag.

The social network processing unit is configured to perform, on the social network service, a process showing that the user has one of interests and concerns regarding one of the object and the event.

The non-contact tag is configured to store social network identifying information for identifying social network services, and the social network processing unit is configured to perform, on a social network service corresponding to the social network identifying information read from the non-contact tag by the tag reader, a process showing that the user has one of interests and concerns regarding one of the object and the event.

The information communication apparatus further includes a display unit. The social network processing unit is configured to display, on the display unit, social network information including a social button with respect to the social network service, and to perform, on the social network service, a process corresponding to the social button.

The information communication apparatus further includes an input unit. The social network processing unit is configured to perform the process on the social network service in response to an operation of the social button performed by the user via the input unit.

The social network processing unit is configured to perform the process on the social network service through an authentication process of the user with respect to the social network service corresponding to the social button operated by the user.

The non-contact tag further stores object identifying information for identifying one of the object and the event, and the social network processing unit is configured to display, on the display unit, the object identifying information read from the non-contact tag, and to perform, on the social network service, a process showing that the user has one of interests and concerns regarding one of the object and the event identified by the object identifying information.

According to an embodiment of the present disclosure, there is provided an information communication method including detecting an operation performed by a user in a real world, and performing a predetermined process on a social network service based on the detection results obtained in the detecting.

According to an embodiment of the present disclosure, there is provided an information communication system including a non-contact tag placed near one of an object and an event in a real world, the non-contact tag being configured to store identifying information of one of the object and the event and social network identifying information, and an information terminal configured to read information from the non-contact tag, and to perform, on a social network service, a process in which a user has one of interests and concerns regarding one of the object and the event, in response to an operation in which the user passes over the non-contact tag.

It should be noted that the “system” represents a logical aggregation of a plurality of apparatuses (or functional modules for achieving a specific function), and each apparatus or functional module is not necessarily in a single casing.

According to an embodiment of the present disclosure, there is provided a computer program that is described in a computer-readable form and causes a computer to function as a communication unit configured to connect to a network, a detection unit configured to detect an operation performer by a user in a real world, and a social network processing unit configured to perform a predetermined process on a social network service based on the detection results obtained from the detection unit via the communication unit.

The computer program is defined as a computer program that is described in a computer-readable form so that a predetermined process can be achieved on a computer. In other words, by installing the computer program on a computer, a cooperative operation is exerted on the computer, and it is possible to obtain the similar operational effect to that of the information communication apparatus.

According to the present disclosure, it is possible to provide an excellent information communication apparatus, information communication method, information communication system, and computer program, which are capable of inputting/outputting information obtained in a real world, e.g., real product to/from a social medium by a simple operation.

According to the present disclosure, a user can provide information for outputting his/her interests or concerns about the real world, e.g., real product, to the social medium via a medium such as an NFC tag placed in the real world. Therefore, the user can express his/her interests or concerns to the community members by a simple operation of passing an information terminal provided with an NFC reader and an NFC application 401 over the NFC tag. Thus, a high advertisement effect can be obtained.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram schematically showing a configuration of an information communication system 100 according to an embodiment of the present disclosure;

FIG. 2 is a diagram showing an internal configuration example of an information terminal 103;

FIG. 3 is a diagram showing a configuration example of an NFC reader 210 in the information terminal 103 and a NFC tag 102;

FIG. 4 is a diagram showing a configuration in which the information terminal 103 processes information read from the NFC tag;

FIG. 5 is a diagram for explaining a mechanism in which information is broadcast to a community via a social plugin;

FIG. 6 is a diagram showing a configuration example of data stored in the NFC tag 102;

FIG. 7 is a flowchart showing a processing procedure for the information terminal 103 to transfer interests or concerns about a product 101 expressed by a user to a social network by using the information read from the NFC tag 102;

FIG. 8 is a diagram showing a configuration example of an application screen “RealLike”;

FIG. 9 is a diagram showing a state where a social button of a social network service is clicked on the application screen “RealLike”;

FIG. 10 is a diagram showing an example of a display screen on which an authentication process to the social network service is prompted on the application screen “RealLike”;

FIG. 11 is a diagram showing a configuration example of a screen obtained by broadcasting a notification of clicking the “Like” button in the page of Facehook by a user A to his/her friend.

FIG. 12 is a diagram showing a display example of a state message showing that clicking the “Like” button is updated in Facebook; and

FIG. 13 is a diagram showing a state where the processed “Like” button is switched to the “Liked” button in social network information (SNSInfo).

### DETAILED DESCRIPTION OF EMBODIMENTS

Hereinafter, an embodiment of the present disclosure will be described with reference to the drawings.

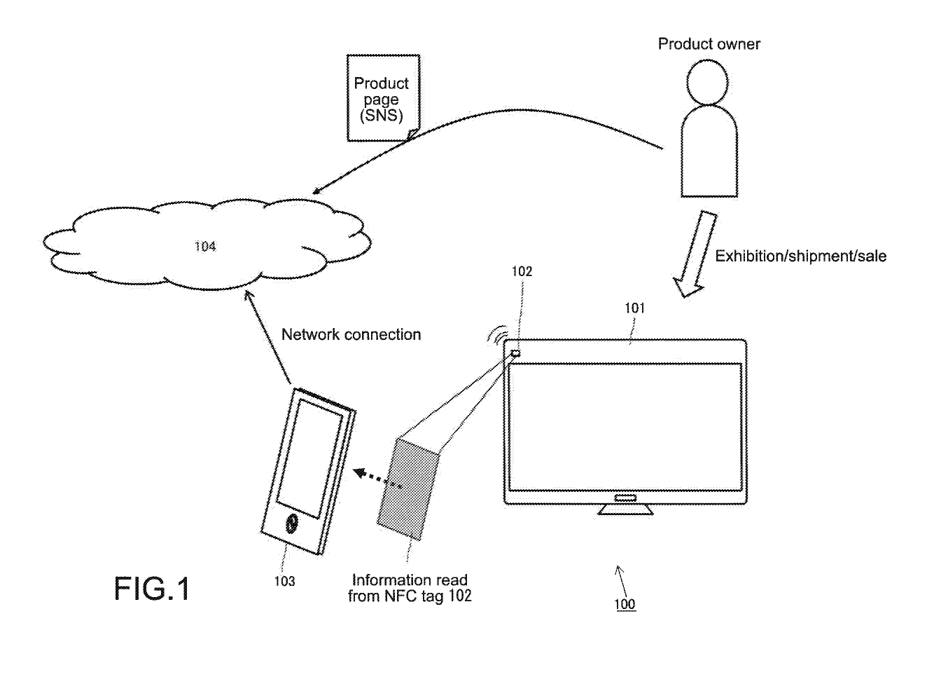

FIG. 1 schematically shows a configuration of an information communication system 100 according to an embodiment of the present disclosure.

A reference number 101 represents a real product existed in a real world, and the product 101 is exhibited in a showcase, for example. It should be noted that the product 101 is assumed to be exhibited in a public place but does not need to be placed in a showcase.

A reference number 102 represents an NFC tag storing information on the product 101. The NFC tag 102 is disposed sufficiently close to the product 101 so that it can be seen that the NFC tag 102 is attached to the product 101 at first sight.

Here, NFC (Near Field Communication) standards, which have become international standards as ISO/IEC IS 18092 as of December 2003, are protocols for enabling non-contact bidirectional proximity communication at distances up to about 10 cm using electromagnetic induction.

A reference number 103 represents an information terminal held by a user. The information terminal 103 is, for example, a multi-functional terminal such as a smartphone. The information terminal 103 has a function to connect to a network such as an Internet 104 and is provided with a browser for browsing and searching for web pages such as a product page. In this embodiment, the information terminal 103 is provided with an NFC reader (to be described later) that reads information from the NFC tag 102 and an NFC application 401 that processes the information read from the NFC tag 102.

Moreover, in this embodiment, various web pages including a product page that introduces the product 101 exhibited in a showcase are published, and various social network services such as Facebook and Twitter are developed on the Internet 104.

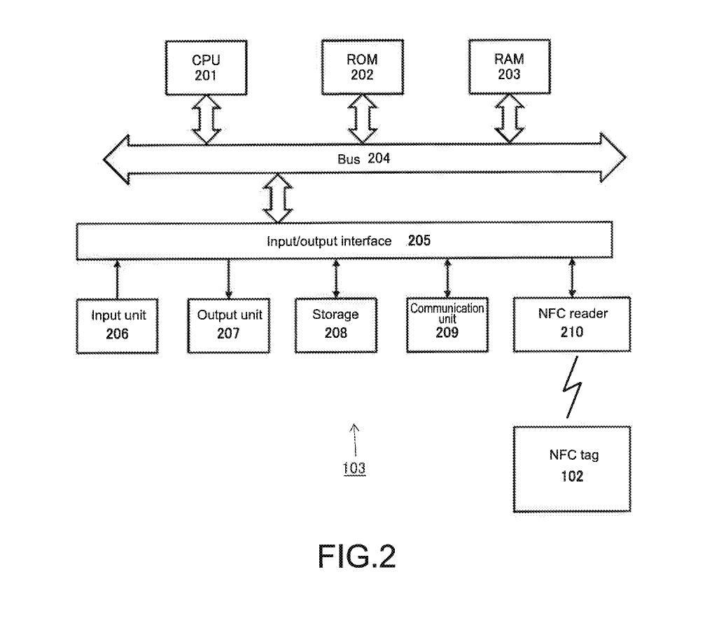

FIG. 2 shows an internal configuration example of the information terminal 103.

A CPU (Central Processing Unit) 201, a ROM (Read Only Memory) 202, and a RAM (Random Access Memory) 203 are connected to each other via a bus 204.

Furthermore, an input/output interface 205 is connected to the bus 204. To the input/output interface 205, an input unit 206 including a touch panel, a button, a key, or the like, and an output unit 207 including a display, a speaker, or the like, are connected. Moreover, to the bus 204, a storage 208 including a non-volatile memory or the like, a communication unit 209 including a network interface, a mobile phone function, or the like, and an NFC reader 210 that reads information from the NFC tag 102 are connected.

The CPU 201 executes a program loaded into the RAM 203. The program executed by the CPU 201 is stored in the storage 208, for example. Alternatively, the program is provided via a transmission medium such as a network and a mobile phone network and is installed in the storage 208.

The operation of the information terminal 103 according to this embodiment is based on the assumption that the NFC application 401 that processes the information read from the NFC tag 102 via the NFC reader 210 is installed and the CPU 201 executes the NFC application 401.

It should be noted that the program executed by the CPU 201 in the information terminal 103 may be a program processed in time series in the order described in the present specification, or a program processed in parallel or at necessary timing such as when being called.

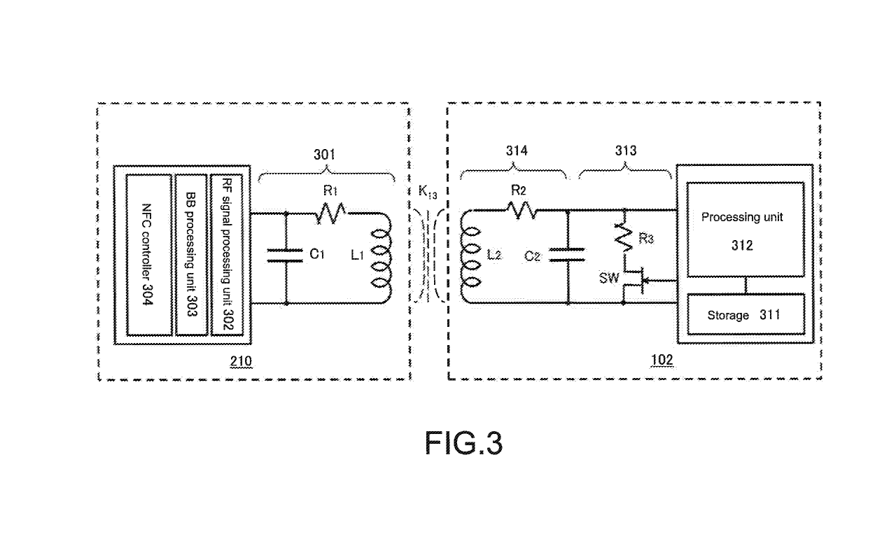

FIG. 3 shows a configuration example of the NFC reader 210 in the information terminal 103 and the NFC tag 102. The NFC represents a non-contact communication system using an electromagnetic induction method, and FIG. 3 illustrates mainly a configuration example of an inductive coupling portion.

The NFC reader 210 is provided with an antenna resonance circuit 301, an RF signal processing unit 302, a baseband (BB) processing unit 303, and an NFC controller 304. The antenna resonance circuit 301 includes a resistor R₁, a capacitor C₁, and a coil L₁, receives an information signal from the NFC tag 102, and supplies the information signal to the RF signal processing unit 302. It should be noted that a unique resonance frequency of the antenna resonance circuit 301 is set to a predetermined value in advance by capacitance of the capacitor C₁ and inductance of the coil L₁.

When reading information from the NFC tag 102, the NTC reader 210 transmits a non-modulated signal via the antenna resonance circuit 301. Then, the RF signal processing unit 302 down-converts an RF signal transmitted from the NFC tag 102 into a baseband signal. The baseband processing unit 303 performs analog/digital conversion of a baseband signal, and demodulates/decrypts the signal into an original digital data. The NFC controller 304 controls the operation of reading information from the NFC tag 102.

On the other hand, the NFC tag 102 is provided with a storage 311, a processing unit 312, a load switching modulation circuit 313, and an antenna resonance circuit 314. The storage 311 stores information on the product 101. The processing unit 312 reads information from the storage 311, and generates transmission information. The antenna resonance circuit 314 includes a resistor R₂, a capacitor C₂, and a coil L₂. The resonance frequency of the antenna resonance circuit 32 is set to a predetermined value in advance by capacitance of the capacitor C₂ and inductance of the coil L₂.

When the NFC tag 102 transmits information, the load switching modulation circuit 313 performs load modulation of the non-modulated signal received by the antenna resonance circuit 314 from the NFC reader 210 based on transmission information generated by the processing unit 312. Then, the antenna resonance circuit 314 transmits the information signal to an antenna (coil L₂) on the side of the NFC reader 210. Moreover, the antenna resonance circuit 314 receives an information signal from the side of a reader/writer, and supplies the information signal to the processing unit 312.

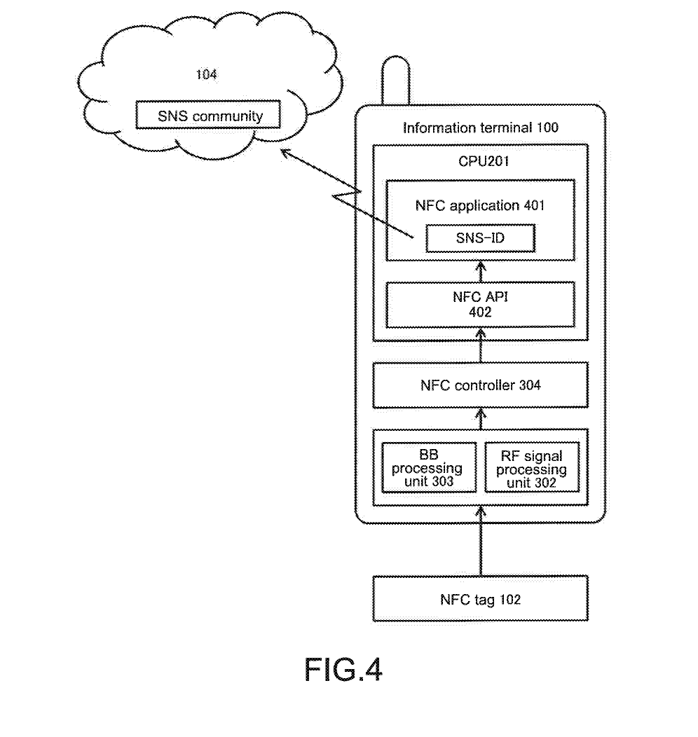

FIG. 4 shows a configuration in which the information terminal 103 processes information read from the NFC tag.

The NFC controller 304 performs a polling operation of the NFC tag 102 via the baseband processing unit 303 and the RF signal processing unit 302 in the NFC reader 210, for example. On the other hand, the NFC tag 102 is capable of transmitting an information signal superimposed with a non-modulated signal from the NFC reader 210. Then, the NFC reader 210 is capable of detecting the NFC tag 102 by receiving a response signal with respect to the polling. Moreover, the NFC controller 304 generates an interrupt event for notifying the CPU 201 of the detection result of the NFC tag 102.

The CPU 201 executes the NFC application 401. The NFC application 401 is capable of performing interaction with the NFC reader 210 via an NFC API (Application Program Interface) 402 provided by an operating system (not shown) or the like.

When detecting the NFC tag 102, the NFC controller 304 notifies the NFC application 401 of it. The NFC application 401 instructs the NFC controller 304 to read information from the NFC tag 102 via the NFC API 402. The NFC controller 304 reads information from the NFC tag 102 via the baseband processing unit 303 and the RF signal processing unit 302.

Then, the NFC application 401 interprets the information read from the NFC tag 102 and processes it. For example, when social network identifying information (SNS-ID) is read from the NFC tag 102, an authentication process for participating in the corresponding social network and a social plugin provided in a social network (i.e., input/output of information to/from a social medium) are executed.

In this embodiment, as shown in FIG. 1, the NFC tag 102 storing information for displaying the product page regarding the product 101 is placed near the product 101 in the real world. If the user passes the information terminal 103 over the NFC tag 102 placed near the product 101 in the real world, the NFC application 401 installed in the information terminal 103 reads information from the NFC tag 102 via the NFC reader 210. Then, the NFC application 401 uses the information read from the NFC tag 102 to display a product page for transferring user's interests or concerns about the product 101 to the social network. Therefore, the user can use the information taken out from the real world to transfer his/her interests or concerns about the product 101 to the virtual world, i.e., community in the social network in which he/she participates. Moreover, a product owner that manufactures or sells the product 101 can use the NFC tag 102 as an advertisement medium regarding the product 101 in the real world.

Here, user's transferring of his/her interests or concerns in the social network corresponds to, for example, clicking the “Like” (which may be “Comment box” or “Send”) button in Facebook or clicking the “Follow” or “Tweet” button in Twitter. On the product page, the above-mentioned social button can be placed by using a social plugin (which is well known).

In the social network, it is possible to perform input/output of information to/from a social medium by using a social plugin. For example, if the user clicks the social button such as “Like” on the product page, information on the product 101 is broadcast to other community members (friends) in the social network.

Here, a mechanism in which information is broadcast to the community via a social plugin will be described.

In Facebook being an example of the social network service, “Wall” on which a user makes a posting and “Newsfield” that displays postings made by friends, i.e., members in the same community in time series, are provided in their pages in Facebook.

Moreover, social buttons such as “Like,” “Comment box,” and “Send” are placed in Facebook. The user can output his/her interests or concerns about a posting made by a friend displayed in the Newsfield to a social medium by clicking the “Like” button with respect to the posting, for example. Then, the social network service has a function to manage the connections between the users, e.g., friendships, and information output to a social medium by a user is transferred to other users by using the management function.

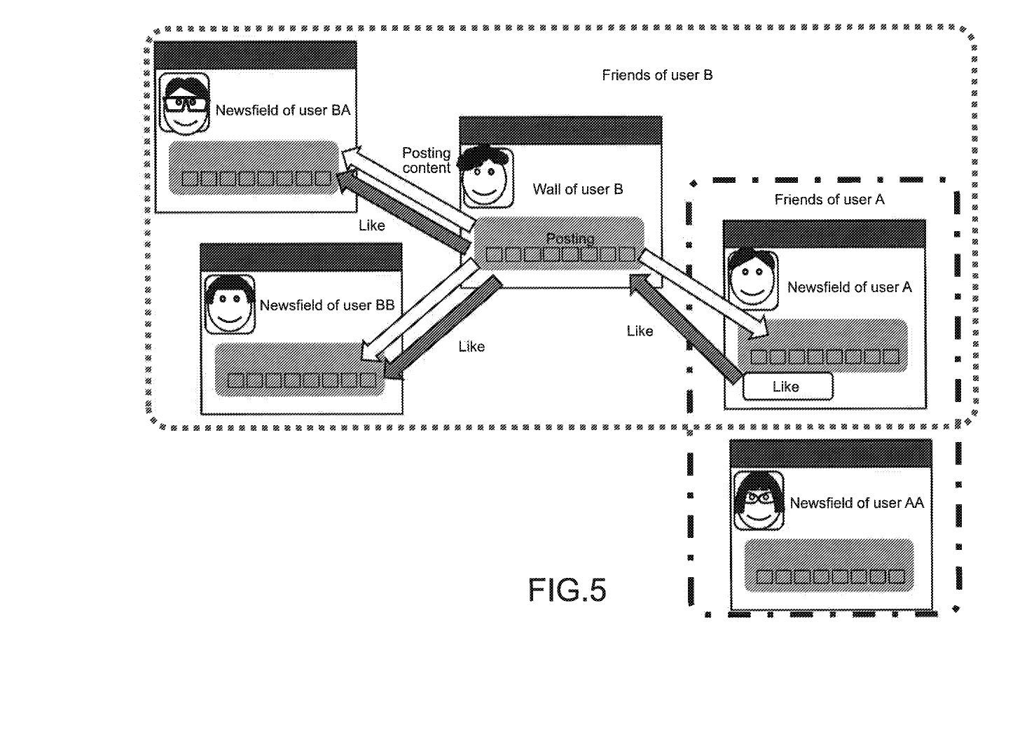

FIG. 5 shows a state in which clicking the “Like” button is output to a social medium and is broadcast to a community. In the illustrated example, it is assumed that a user A and a user B are in a friendship, the user A and a user AA are also in a friendship, and the user B, a user BA, and a user BB are also in a friendship.

The posting made on his/her Wall is displayed also in Newsfields of the user A, the user BA, and the user BB, who are in a friendship with the user B (it should be noted that the posting made by the user B is not displayed in the Newsfield of the user AA who is not in a friendship with the user B). In the Newsfield of each user, postings made by a user and other users who are in a friendship with him/her are transferred in time series.

Here, the user A has interests or concerns about the posting made by the user B displayed in the Newsfield of the user A, and clicks the “Like” button. Then, the result of clicking the “Like” button is displayed on the Wall of the user B being a sender, and is displayed also in the Newsfields of the user BA and the user BB who are other friends of the user B. Thus, interests or concerns of the user A are broadcast to the community (it should be noted that the result of clicking the “Like” button is not reflected on the Newsfield of the user AA who is a friend of the user A but not in a friendship with the user B).

A product owner may create a product page regarding the in-house product 101 in a social network service, or in his/her own host, and store information on the product page in the NFC tag 102. Then, the NFC tag 102 is placed near the real product 101 exhibited in a public place. A user who has interests or concerns about the exhibited product 101 passes his/her information terminal 103 over the NFC tag 102, and thus information stored in the NFC tag 102 is transferred to the information terminal 103. The NFC application 401 installed in the information terminal 103 uses the information read from the NFC tag 102 to display a product page for transferring his/her interests or concerns about the product 101 to the social network.

If the user clicks a social button such as the “Like” button on the product page, information on the product 101 is broadcast to other members (friends) in the social network community, or users who follow him/her. Therefore, the NFC tag 102 can be an advertisement medium that directly broadcasts information from the real world to the community in the virtual world.

In the NFC tag 102, for example, information on the product 101 (ProductInfo) and social network in formation (SNSInfo) used for transferring the information on the product 101 are stored. The product owner can control the social network used for transferring the information on the product 101 by storing the social network identifying information (SNS-ID) for each product identifying information as the SNSInfo in the NFC tag 102. Moreover, in the NFC tag 102, product identifying information (Product-ID) for identifying the product 101 and detailed information (Description) about the product 101 are stored as product information (Froductinfo).

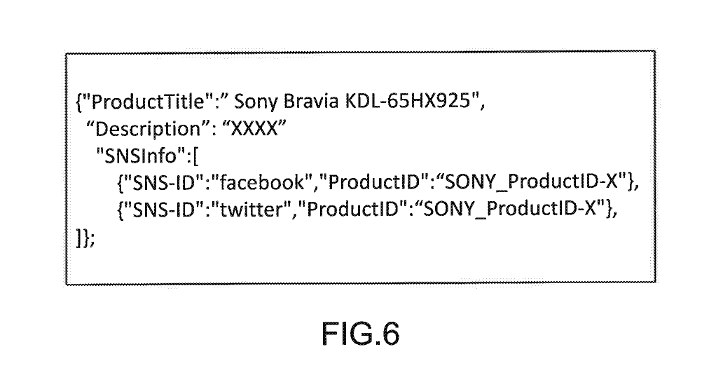

FIG. 6 shows a configuration example of data stored in the NFC tag 102. In the illustrated example, the detailed information “XXXX” on a product name of “Sony Bravia KDL-65HX925” is described as stored data. Moreover, as the SNS Info, SNS-ID*1 (Facebook) and SNS-ID#2 (twitter) are designated with respect to the product identifying information of SONYProductID-X. It should be noted that FIG. 6 is merely an example of the description format of data. For example, a structured description language such as an XML (eXtensible Markup Language) may be used to describe data. Alternatively, data may be described based on a notation format of URL (Uniform Resource Locator).

The NFC application 401 installed in the information terminal 103 is capable of reading stored data shown in FIG. 6 from the NFC tag 102, and extracting product information shown in Table 1 and social network information shown in Table 2.

TABLE 1

| | |
|---|---|
| Product name (Product Title) | Sony Bravia KDL-65HX925 |
| Detailed information (Description) | XXXX |

TABLE 2

| Social network | Product identifying |
|---|---|
| identifying information (SNS-ID) | information (Product ID) |
| Facebook | SONY_ProductID-X |
| Twitter | SONY_ProductID-X |

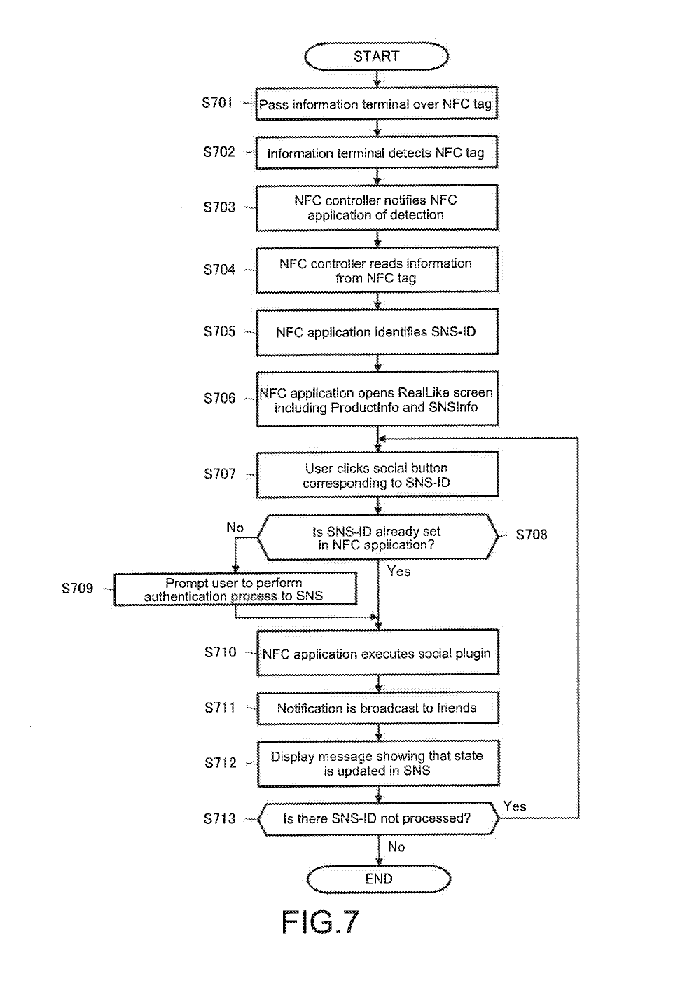

FIG. 7 shows a processing procedure for the information terminal 103 to transfer interests or concerns about the product 101 expressed by a user to a social network by using the information read from the NFC tag 102 in the format of a flowchart.

First, a user passes the information terminal 103 over the NFC tag 102 placed near the product 101 about which he/she has interests or concerns (step S701).

At this time, if the NFC reader 210 in the information terminal 103 detects the NFC tag 102 (Yes in step S702), the NFC reader 210 generates an interrupt event for notifying the NFC application 401 being executed in the CPU 201 of the detection result (step S703).

Then, the NFC application 401 reads information stored in the NFC tag 102 via the NFC controller 304 (step S704).

As descrined above, in the NFC tag 102, product identifying information (Product-ID) for identifying the product 101 and social network information (SNSInfo) used for transferring information on the product 101 are stored, for example.

If the NFC application 401 identifies social network information from information read from the NFC tag 102 (step S705), the NFC application 401 opens an application screen “RealLike” including the product information (ProductInfo) read from the NFC tag 102 and the social network information (SNSlnfo) (step S706).

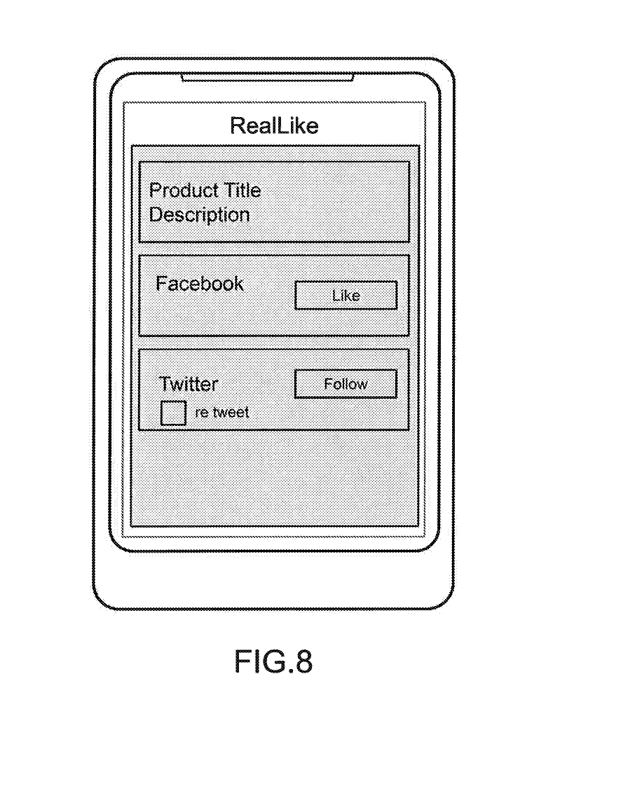

FIG. 8 shows a configuration example of the application screen “RealLike.” In the illustrated example, a product name (Product Title) and detailed information (Description) on the product 101 are displayed as the product information (ProductInfo). Moreover, as the social network information (SNSInfo), information on social network services, i.e., “Facebook” and “Twitter,” associated with the product 101, is displayed with a respective social button “Like” or “Follow.” It should be noted that a check box of “re tweet” is placed as social network information in Twitter. If the re tweet is selected as an option, all tweets from the product page of the product 101 are retweeted to all friends of the user.

The application screen “RealLike” is intended to directly activate a social plugin such as the “Like” and the “Follow” buttons by an operation of passing the information terminal 103 over the NFC tag 102 of the real product 101 about which the user has interests or concerns in the real world.

The user can click (or tap on a touch panel) a social button corresponding to arbitrary social network identifying information (SNS-ID) on the application screen “RealLike” (step S707).

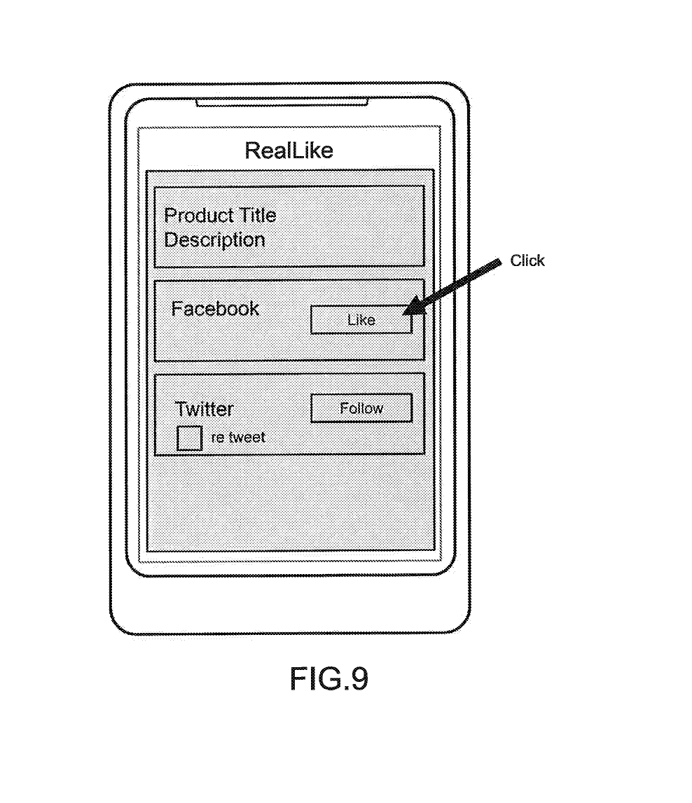

FIG. 9 shows a state where the social button, “Like,” of the social network service, “Facebook,” is clicked on the application screen “RealLike.”

If the social button is clicked, the NFC application 401 checks whether or not account information (user name and password for logging in the social network service) with respect to the corresponding social network identifying information (SNS-ID) is already set in the application, i.e., whether or not an authentication process with respect to the social network service is already finished (step S708).

Here, when account information with respect to the social network identifying information (SNS-ID) is not yet set in the NFC application 401 (No in step S708), the NFC application 401 prompts the user to perform an authentication process to the social network service.

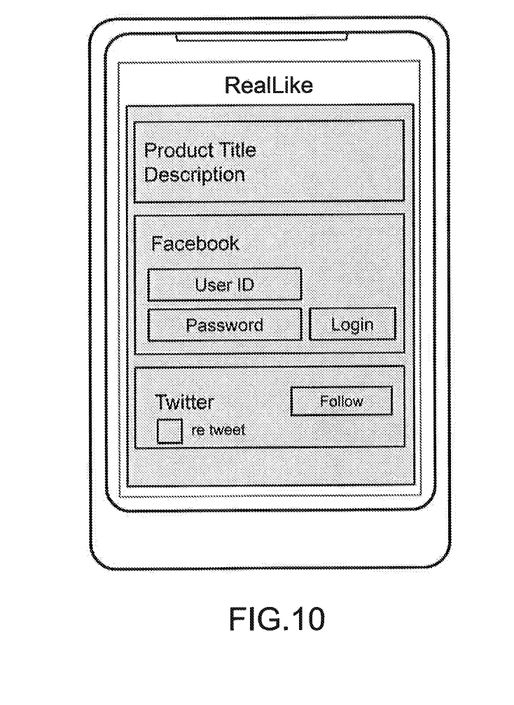

FIG. 10 shows an example of a display screen on which an authentication process to the social network service, “Facebook,” is prompted on the application screen “RealLike.” In the illustrated example, input fields of a user name (User ID) and a password (Password) and a login (Login) button are placed in “Facebook.”

In the case where account information with respect to the social network identifying information (SNS-ID) is determined to be already set (Yes in step S708), or in the case where the authentication process (step S709) is successfully finished, the NFC application 401 executes a process with respect to a social button clicked regarding the product 101 in the social network service, i.e., social plugin (step S710).

It should be noted that the NFC application 401 may automatically activate the processes of logging in the social network service and social plugin without waiting for the social button to be clicked on the application screen “RealLike.”

As a result of executing the social plugin, a notification showing that the user has interests or concerns about the product 101 is output to the social medium. As a result, the notification is broadcast to the friends (community) of the user in the social network service (step S711).

For example, if a user clicks the “Like” button in his/her own page of Facebook via the application screen “RealLike,” a notification showing that the user clicks the “Like” button according to the mechanism shown in FIG. 5 is broadcast to friends of the user.

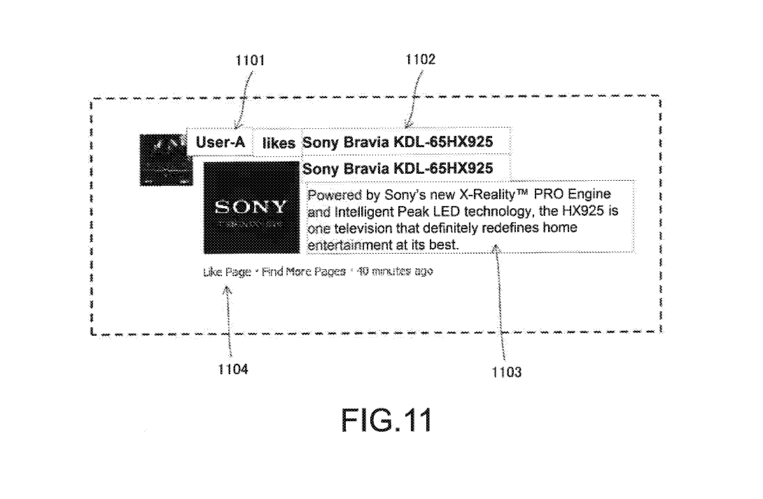

Moreover, FIG. 11 shows a configuration example of a screen obtained by broadcasting a notification of clicking the “Like” button in the page of Facebook by the user A to his/her friend. In the illustrated example, it is assumed that the user A (User-A) has interests or concerns about the product “Sony Bravia KDL-65HX925” exhibited in the real world and clicks the “Like” button in his/her page in Facebook via the application screen “RealLike.” In the page of the user B (User-B) being his/her friend in Facebook, the user name “User-A” who clicks the “Like” button, which is represented by a reference number 1101, the product name “Sony Bravia KDL-65HX925” on which the user clicks the “Like” button, which is represented by a reference number 1102, and detailed information (product description) of the product, which is represented by a reference number 1103, are displayed. Moreover, in the page of Facebook, an option in which a user's friend also clicks the “Like” button, which is represented by a reference number 1104, is provided. If the friend follows the link to the product page, he/she can browse detailed information on the product or information on the purchasing place or the purchasing method. However, it should be understood that the method of notifying the clicking of the “Like” button is changed depending on the implementation of Facebook.

Once the user causes the NFC application 401 to be authenticated to a server of a social network service such as Facebok, information of clicking a social button such as the “Like” button is updated in Facebook.

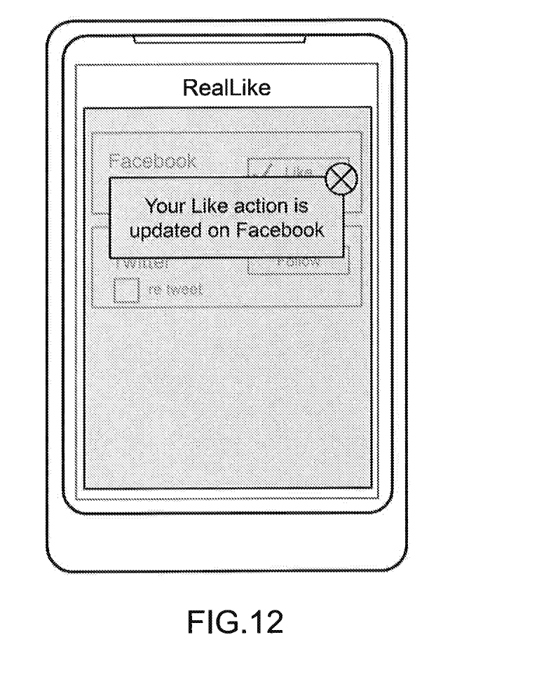

After the above-mentioned notification is performed, in the social network service, the NFC application 401 displays a state message showing that clicking of a social button with respect to the product 101 is updated in the social network service (step S712). FIG. 12 shows a display example of a state message (Your Like action is updated on Facebook) showing that clicking the “Like” button is updated in Facebook.

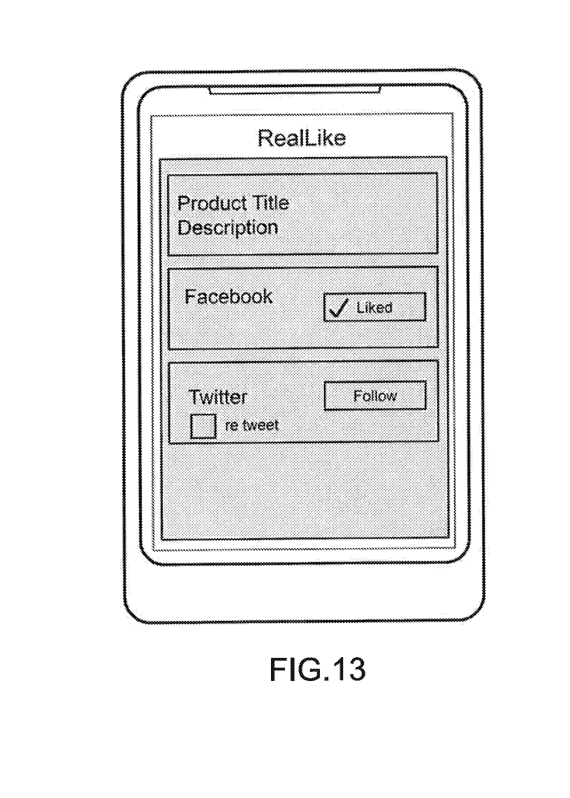

Then, the NFC application 401 switches display of the social button clicked in step S707 to display showing that the button has been clicked on the application screen “RealLike.” For example, “Like” is switched to “Liked”, and “Follow” is switched to “followed.” FIG. 13 shows a state where the processed “Like” button is switched to the “Liked” button in social network information (SNSInfo).

In the case where social network information (SNSInfo) showing that a social button is not operated remains in the application screen “RealLike,” (No in step S713), the process returns to step S707 and a social plugin is repeatedly executed on the remaining social network information (SNSInfo). Moreover, if all of the social buttons with respect to the social network information (SNSinfo) are operated (Yes in step S713), the process routine is finished.

By using the present disclosure, it is possible to perform an advertisement of a new product in a social network. In recent years, the social network is an optimal place for advertising the launching of a new product. Moreover, companies typically place social buttons like the “Like” button in Facebook or “Follow” in Twitter, in their product pages. However, a general consumer can look at a real product displayed in a public place or a store more carefully than in a product page, and understand the product more accurately. According to the present disclosure, the NFC tag 102 is placed near the real product 101 instead of placing a social button in a product page. The general consumer can directly activate a social plugin such as “Like” and “Follow” (i.e., do “RealLike”) by an operation of passing the information terminal 103 over the NFC tag 102 of the real product 101 about which the user has interests or concerns in the real world.

The product page browsed by the information terminal 103 based on the information read from the NFC tag 102 may be a page in a social network service or a page in a unique host, which includes information on the product 101.

Moreover, a general consumer may login a product page via the “RealLike” and click a social button such as the “Like,” if the sales price of the product 101 is considered not reasonable. After that, if there is the discount or sale of the product 101, it is notified to the consumer via the SNS-ID.

As described above, in the information communication system 100 shown in FIG. 1, a user can directly activate a social plugin such as “Like” and “Follow,” i.e., do “RealLike” with respect to the real product 101 by an operation of passing the information terminal 103 over the NFC tag 102 of the real product 101 about which the user has interests or concerns in the real world. It should be noted that a target on which the “RealLike” is done is not limited to a product (Product). For example, the configuration of the information communication system 100 may be modified or changed such that the “RealLike” is performed on the following objects or events in the real world.
(1) Art object
(2) View point
(3) Event
(4) News
(5) Amusement attraction
(6) Concert
(7) Building

In the case of the above, the NFC tag 102 may be placed near the object or event. Moreover, in the NFC tag 102, identifying information for identifying the object or event and detailed information may be stored together with social network identifying information on which the “RealLike” is done.

It should be noted that the present disclosure may also take the following configurations.

(1) An information communication apparatus, including:

a communication unit configured to connect to a network;

a detection unit configured to detect an operation performed by a user in a real world; and

a social network processing unit configured to perform a predetermined process on a social network service based on the detection results obtained from the detection unit via the communication unit.

(2) The information communication apparatus according to (1), in which

the detection unit includes a tag reader and is configured to detect an operation in which the user passes a main body of the information communication apparatus over a non-contact tag, the tag reader being configured to read information from the non-contact tag, and

the social network processing unit is configured to perform a predetermined process on the social network service in response to the operation in which the user passes the main body of the information communication apparatus over the non-contact tag.

(3) The information communication apparatus according to (2), in which

the social network processing unit is configured to perform a predetermined process on the social network service based on the information read from the non-contact tag by the tag reader.

(4) The information communication apparatus according to (2), in which

the non-contact tag is placed near one of an object and an event in the real world, and

the social network processing unit is configured to perform a predetermined process on a social network service associated with one of the object and the event in response to the operation in which the user passes the main body of the information communication apparatus over the non-contact tag.

(5) The information communication apparatus according to (4), in which

the social network processing unit is configured to perform, on the social network service, a process showing that the user has one of interests and concerns regarding one of the object and the event.

(6) The information communication apparatus according to (4), in which

the non-contact tag is configured to store social network identifying information for identifying social network services, and

the social network processing unit is configured to perform, on a social network service corresponding to the social network identifying information read from the non-contact tag by the tag reader, a process showing that the user has one of interests and concerns regarding one of the object and the event.

(7) The information communication apparatus according to (6), further including

a display unit, wherein

the social network processing unit is configured
to display, on the display unit, social network information including a social button with respect to the social network service, and
to perform, on the social network service, a process corresponding to the social button.

(8) The information communication apparatus according to (7), further including

an input unit, wherein

the social network processing unit is configured to perform the process on the social network service in response to an operation of the social button performed by the user via the input unit.

(9) The information communication apparatus according to (8), in which

the social network processing unit is configured to perform the process on the social network service through an authentication process of the user with respect to the social network service corresponding to the social button operated by the user.

(10) The information communication apparatus according to (7), in which

the non-contact tag further stores object identifying information for identifying one of the object and the event, and

the social network processing unit is configured
to display, on the display unit, the object identifying information read from the non-contact tag, and
to perform, on the social network service, a process showing that the user has one of interests and concerns regarding one of the object and the event identified by the object identifying information.

(11) An information communication method, including:

detecting an operation performed by a user in a real world; and

performing a predetermined process on a social network service based on the detection results obtained in the detecting.

(12) An information communication system, including:

a non-contact tag placed near one of an object and an event in a real world, the non-contact tag being configured to store identifying information of one of the object and the event and social network identifying information; and

an information terminal configured
to read information from the non-contact tag, and
to perform, on a social network service, a process in which a user has one of interests and concerns regarding one of the object and the event, in response to an operation in which the user passes over the non-contact tag.

(13) A computer program that is described in a computer-readable form and causes a computer to function as:

a communication unit configured to connect to a network;

a detection unit configured to detect an operation performed by a user in a real world; and

a social network processing unit configured to perform a predetermined process on a social network service based on the detection results obtained from the detection unit via the communication unit.

Hereinabove, the present disclosure has been described in detail with reference to specific embodiments. However, it is obvious that various modifications or substitutions can be made to the embodiments of the present disclosure by a person skilled in the art without departing from the gist of the present disclosure.

In the present specification, although an embodiment in which information related to a product such as SNS_ID is delivered by using an NFC tag has been described, the present disclosure is not limited to such an information transmission medium. The information terminal 103 can apply a non-contact communication method using electromagnetic induction other than the NFC, a non-contact communication method based on another principle such as a static electricity method, an optical reading method, or the like, to read information from the real world. For example, it is possible to transmit similar information via a two-dimensional bar code attached on a side of a product. In this case, an information terminal may be provided with a bar code reader, or a camera and a decoder for decoding information embedded in the bar code from an image photographed by the camera.

In short, the present disclosure has been described in the form of an example, and the description in the present specification should not be interpreted in a limited way. In order to determine the gist of the present disclosure, the scope of claims should be considered.

It should be understood by those skilled in the art that various modifications, combinations, sub-combinations and alterations may occur depending on design requirements and other factors insofar as they are within the scope of the appended claims or the equivalents thereof.

What is claimed is:

1. An information communication apparatus, comprising:
a communication unit configured to connect to a network;
a detection unit configured to detect an operation performed by a user in a real world; and
a social network processing unit configured to perform a predetermined process on a social network service based on the detection results obtained from the detection unit via the communication unit.

2. The information communication apparatus according to claim 1, wherein
the detection unit includes a tag reader and is configured to detect an operation in which the user passes a main body of the information communication apparatus over a non-contact tag, the tag reader being configured to read information from the non-contact tag, and
the social network processing unit is configured to perform a predetermined process on the social network service in response to the operation in which the user passes the main body of the information communication apparatus over the non-contact tag.

3. The information communication apparatus according to claim 2, wherein
the social network processing unit is configured to perform a predetermined process on the social network service based on the information read from the non-contact tag by the tag reader.

4. The information communication apparatus according to claim 2, wherein
the non-contact tag is placed near one of an object and an event in the real world, and
the social network processing unit is configured to perform a predetermined process on a social network service associated with one of the object and the event in response to the operation in which the user passes the main body of the information communication apparatus over the non-contact tag.

5. The information communication apparatus according claim 4, wherein
the social network processing unit is configured to perform, on the social network service, a process showing that the user has one of interests and concerns regarding one of the object and the event.

6. The information communication apparatus according to claim 4, wherein
the non-contact tag is configured to store social network identifying information for identifying social network services, and
the social network processing unit is configured to perform, on a social network service corresponding to the social network identifying information read from the non-contact tag by the tag reader, a process showing that the user has one of interests and concerns regarding one of the object and the event.

7. The information communication apparatus according to claim 6, further comprising
a display unit, wherein
the social network processing unit is configured
to display, on the display unit, social network information including a social button with respect to the social network service, and
to perform, on the social network service, a process corresponding to the social button.

8. The information communication apparatus according to claim 7, further comprising
an input unit, wherein
the social network processing unit is configured to perform the process on the social network service in response to an operation of the social button performed by the user via the input unit.

9. The information communication apparatus according to claim 8, wherein
the social network processing unit is configured to perform the process on the social network service through an authentication process of the user with respect to the social network service corresponding to the social button operated by the user.

10. The information communication apparatus according to claim 7, wherein
the non-contact tag further stores object identifying information for identifying one of the object and the event, and
the social network processing unit is configured
to display, on the display unit, the object identifying information read from the non-contact tag, and
to perform, on the social network service, a process showing that the user has one of interests and concerns regarding one of the object and the event identified by the object identifying information.

11. An information communication method, comprising
detecting an operation performed by a user in a real world; and
performing a predetermined process on a social network service based on the detection results obtained in the detecting.

12. An information communication system, comprising:
a non-contact tag placed near one of an object and an event in a real world, the non-contact tag being configured to store identifying information of one of the object and the event and social network identifying information; and
an information terminal configured
to read information from the non-contact tag, and
to perform, on a social network service, a process in which a user has one of interests and concerns regarding one of the object and the event, in response to an operation in which the user passes over the non-contact tag.

13. A computer program that is described in a computer-readable form and causes a computer to function as:
a communication unit configured to connect to a network;
a detection unit configured to detect an operation performed by a user in a real world; and
a social network processing unit configured to perform a predetermined process on a social network service based on the detection results obtained from the detection unit via the communication unit.
